(19) United States
(12) Patent Application Publication
(10) Pub. No.: US 2018/0148005 A1
(43) Pub. Date: May 31, 2018

(54) System and Method for Use With a Combustion Engine

(71) Applicant: Jason Haines, Fort Wayne, IN (US)

(72) Inventor: Jason Haines, Fort Wayne, IN (US)

(21) Appl. No.: 15/362,085

(22) Filed: Nov. 28, 2016

(51) Int. Cl. B60R 16/023; F02D 41/26; F02D 41/30; F02D 41/00

(52) U.S. Cl. CPC B60R 16/0231; F02D 41/26; F02D 41/30; F02D 2200/0404; F02D 41/0002; F02D 2200/0406; F02D 2200/0414; F02D 41/0007

(57) ABSTRACT

The present invention pertains to a system and method for use in a combustion-engine to mediate between sensors and an electronic control unit, in order to facilitate improved, more efficient, better, or alternate desired engine function without modifying or replacing the control unit through the selective modification, combination, or elimination of desired sensor signals.

### CROSS-REFERENCES TO RELATED APPLICATIONS

Not applicable.

### STATEMENT REGARDING FEDERALLY SPONSORED RESEARCH OR DEVELOPMENT

Not applicable

### BACKGROUND

It is common in the art of modern engine manufacture, and particularly the manufacture of vehicles including combustion engines, to include in the engine a computer electronic control unit, or ECU, to regulate a variety of functions, including fuel consumption, emissions, and even actuation of the throttle or transmission. ECUs typically operate by monitoring the outputs of a variety of sensors located throughout the vehicle, performing pre-programmed functions responsive to that data, then providing outputs to direct the function of components of the vehicle. ECUs typically read outputs from dozens of sensors, including, by way of example, sensors monitoring mass airflow, intake manifold pressure, exhaust oxygen content, coolant temperature, throttle position, crank position, cam position, air temperature, and vehicle speed. Based on the readings of these and other inputs, the ECU generates control or information outputs to regulate the function of the vehicle or to provide data to the driver. Common ECU outputs include providing data to the driver instrument cluster and regulating operation of the fuel injectors, fuel pump, ignition coils, and transmission.

Copies of the same ECU hardware may be installed in a variety of different vehicles. As will be apparent to one skilled in the art, variations between vehicles, such as variations in the size, weight, or engine size, will alter the relationship between the inputs received by the ECU and the vehicle-specific appropriate informational or control outputs generated by the ECU. It is known in the art to calibrate an ECU for each specific vehicle with functional parameters, such as a data table configured to ensure that the ECU generates desirable vehicle-specific outputs for each set of sensor inputs. Provision of such data tables to the ECU may occur through, for example, updating the ECU software, or firmware through download or “flashing,” or even replacement of an ECU data chip such as an EPROM chip.

It is known in the art to modify an existing ECU by physically or electronically changing the functional parameters or performance of the ECU, such as by modifying or changing the firmware or software, or replacing the ECU hardware. Modification of ECUs is sometimes made to improve engine performance, and may also become necessary or desirable if stock parts or sensors within the vehicle are replaced with parts that function differently, provide different sensor outputs, or provide sensor outputs in different formats, than the stock parts they replaced.

Various challenges exist to modifying vehicles with aftermarket parts that impact sensor readings monitored by an ECU. The stock functional parameters of the ECU often result in undesirable, less efficient, or poorly performing vehicle function if those functional parameters are used in connection with aftermarket parts. Additionally, ECUs are often not configured or not configurable to drive auxiliary or additional devices, such as aftermarket parts that may be added to a vehicle. Such aftermarket parts include, for two of many possible examples, electronic fuel pressure regulators or water injection solenoids.

Modifying or adapting an ECU to achieve improved, more efficient, or alternate desired function, including but not limited to after the installation of aftermarket parts, presents additional challenges. Difficult and time-intensive work may be required to program new functional parameters that result in the desired function. Additionally, some aftermarket parts may result in sensor signals being presented to the ECU in a format incompatible with the ECU's programming, or in a range outside of the value range the ECU is programmed to handle. Additionally, some aftermarket modifications may result in the vehicle presenting more sensor signals of a specific type than the ECU is configured to accept, or new sensor signal types that the ECU is not configured to accept. Additionally, an ECU may not be configured, or configurable, to properly drive or control certain additional or auxiliary parts added to the vehicle.

### SUMMARY

The present invention is directed to a system and method for use in a combustion engine, including stationary engines and engines powering vehicles, vehicle to mediate between sensors and an ECU in order to facilitate improved, more efficient, better, or alternate desired function. In the case of combustion engine vehicles, such improved, more efficient, better, or alternate-desired function could be desired, by way of non-limiting example, after the installation of parts affecting the input of sensors monitored by the ECU, including prototype, experimental, OEM, non-OEM, or aftermarket parts, systems, or modules, including additional or auxiliary parts, or after the alteration of stock parts, all without requiring replacement or reprogramming of the ECU. The system and method of embodiments of the present invention are directed to adapting or modifying sensor signal inputs to the ECU, and in some embodiments, adapting or modifying ECU control outputs back to components of the vehicle.

In one embodiment, the system and method utilizes a device capable of receiving signals from at least one sensor in a vehicle, modifies the signal or signals by increasing or decreasing the magnitude of the signal or signals, and transmits the modified signal to an ECU. In another embodiment, the system and method utilizes a device capable of receiving signals from at least one sensor in a vehicle, modifies the signal or signals by scaling the signal according to a selected factor or as a selected function of input values, and transmits the modified signal to an ECU. In another embodiment, the system and method utilizes a device capable of receiving a signal from at least one sensor in a vehicle, modifies the signal by adapting it from one format to another, and transmits the modified signal to an ECU.

In another embodiment, the system and method utilizes a device capable of receiving signals from at least two sensors in a vehicle, and combines those signals by adding, subtracting, or averaging them, and transmits the combined signal to an ECU. In another embodiment, the system and method utilizes a device capable of receiving signals from at least two sensors in a vehicle, and modifies those signals by altering or delaying the timing or order of one or more than one of the signals, and delivers the modified signal set to an ECU.

In a preferred embodiment, the system and device receives signals from at least one sensor, such as a sensor reading outputs from an aftermarket component, and, if specified conditions are met, clips the signal to maintain ECU compatibility, and the device then utilizes one or more of the clipped signal, the difference between the clipped signal and unclipped signal, or a mathematical function of the clipped signal or of the difference between the clipped signal and unclipped signal to drive an additional or auxiliary component within the vehicle. Specified conditions may include, by way of example, the signal received exceeding the range of values recognized by the ECU, a sensor of a different signal type than that for which the ECU is programmed, or the use of additional aftermarket sensors in series to result in a signal with a range of values not anticipated by the ECU's original programming. In other embodiments, the system and method of the present invention performs two or more of the functions of any of the above-stated embodiments simultaneously. It is within the scope of these embodiments for the system and device to receive multiple signals, such as one, two, three, or more signals, to modify a desired number of the signals, and to transmit multiple signals, such as one, to, three, or more signals to the ECU, with the number of signals transmitted to the ECU not necessarily being the same number as the number of signals received by the system and device. It is further within the scope and spirit of this invention for the system and device to perform multiple operations (such as, by way of non-limiting example, both clipping and combination) to one, some, or all received signals, and to apply differing operations to differing signals, multiple operations to the same signal, or any combination thereof.

### BRIEF DESCRIPTION OF THE DRAWINGS

These and other features, aspects, and advantages of the present invention will become better understood with regard to the following description and accompanying drawings, where:

FIG. 1 is a flow chart demonstrating one preferred embodiment of the present invention;

FIG. 2 is a flow chart demonstrating an embodiment of the present invention utilizing two MAF sensors;

FIG. 3 is a flow chart demonstrating an embodiment of the present invention utilizing two MAP sensors;

FIG. 4 is a flow chart demonstrating an alternate embodiment of the present invention utilizing two MAF sensors in connection with a split air inlet;

FIG. 5 is a flow chart demonstrating an embodiment of the present invention utilizing various control outputs;

FIG. 6 is a flow chart demonstrating an alternate embodiment of the present invention utilizing various control outputs;

FIG. 7 is a flow chart demonstrating an embodiment of the present invention in use in connection with optimizing use of a turbocharger;

FIG. 8 is a flow chart demonstrating the use of the present invention's averaging capabilities across multiple sensors to allow an ECU configured for a single throttle intake manifold to run an engine with a twin plenum, twin throttle intake;

FIG. 9 shows a selection of representative ECU math/function tables.

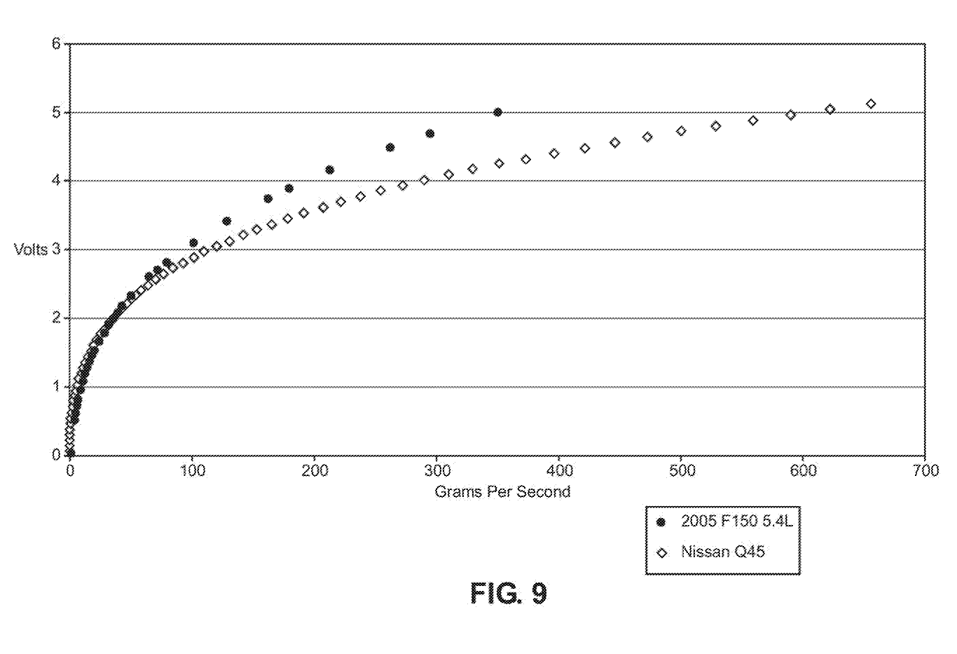

### DETAILED DESCRIPTION

Embodiments of the present invention teach a system that mediates one, two, or more input signals from sensors within a vehicle and modifies, combines, adapts those signals, then transmits the modified, combined, or adapted signal to the vehicle's ECU. In reference to the specific embodiments discussed herein, a number of standard automotive terms and part names may be used to explain the operation and/or steps of the invention. Automotive part or assemblies, which will be understood to one skilled in the art as relevant to understanding the present invention not specifically discussed elsewhere herein include the air filter assembly 113, throttle 115, intake manifold 117, and exhaust manifold 119

As used herein, the term “ECU” may refer to an electronic control unit, engine control unit, engine control module, powertrain control module, vehicle control module, transmission control module, chassis control module, body control module, or any other embedded computer systems that control one or more vehicle systems based in part on inputs received from vehicle sensors. The various embodiments herein are all described in relation to a vehicle with a combustion engine 1 and with an ECU 3 operatively and electrically connected to the engine 1 and to one or more sensor within the vehicle. “Sensors,” when used herein, refers to any sensor used to sense or record data in a vehicle, and includes generally, by way of example, MAF sensors, 101, MAP sensors, 102, fuel pressure sensors, oxygen sensors, engine coolant temperature sensors, engine RPM sensors, vehicle speed sensors, intake air temperature sensors, 103, catalyst temperature sensors, control module voltage sensors, ambient air temperature sensors, pedal position sensors, supercharger inlet pressure sensors, boost pressure sensors, throttle position sensors 105, crankshaft position sensors 107, camshaft position sensors 109, and engine coolant temperature sensors 111. “Parts,” when used herein, refers to prototype, OEM, non-OEM, or aftermarket parts, systems, or modules, including additional or auxiliary parts, and also refers to altered OEM parts. “Signals” or “data” as used herein refers to any electronic information, including, by way of non-limiting example, discrete digital or analog sensor signals, network signal or variables, or calculations or solutions.

The embodiments described herein include a controller 7 operatively interposed between and electrically connected to at least one sensor and the ECU 3. As will be understood, operative and electrical connection between a controller 7 and one or more than one sensor within the scope of this invention includes both direct wired connection, and indirect connection, such as operative connection by the controller 7 to a vehicle data network to which one or more than one sensor is also operatively connected. The controller 7 may be connected to one, two, three, or more, sensor, up to and including all sensor in the vehicle. Sensor that are not electrically connected to the controller 7 may remain electrically connected only to the ECU according to the manufacturer's specifications.

In the embodiments herein, input signals from at least one sensor are transmitted to the controller 7. The input signals are mediated by the controller according to its programming, and then transmitted to the ECU 3 or, optionally used to generate controller outputs back to components of the vehicle other than the ECU 3. Input signals may be mediated by the controller 7 by simple transmission, with the input signals remaining in an unaltered state, or input signals may be modified, skewed, adapted, combined, or clipped, as described below.

In a preferred embodiment herein, described below, the controller 7 is further operatively connected to one or more automotive components other than the ECU 3, and may provide control outputs to the same. The control outputs provided by the controller 7 to such automotive components are determined by the controller's programming, and may, pursuant to such programming, be determined as a function of one or more than one input signals received by the controller, by ECU outputs generated by the ECU 3, or by a combination of input signals and ECU outputs. Vehicle components operatively connected to, and optionally driven or controlled by, a controller 7 herein may include, by way of example, fuel injectors, 12 ignition coils, fuel pressure regulators, fuel pump controller, boost bypass actuators, camshaft actuator, or throttle actuator. Thus, the system described herein may be utilized to improve or optimize the performance of a vehicle by, for example, providing the controller 7, programming the controller 7 with an optimized, improved, or alternate data table, such as for example, a fuel table, and/or programming the controller 7 with an optimized, improved, or alternate math function, and allowing the controller 7 to alter or override the air/fuel ratios set by manufacturer specification in the ECU to situationally achieve desired air/fuel ratios The system described herein may further operate by providing closed loop feedback inputs to the controller 7, as would be understood by one skilled in the art, to enhance the precision of operation of the device.

In the embodiments herein, the controller 7 is programmed to read certain desired input signals, and to modify, adapt, combine, or alter those signals for transmission to an ECU, and, optionally, to generate control outputs to control vehicle components. To perform these functions, the controller 7 requires programming analogous to the type of programming used to provide instructions to ECUs generally. Specifically, a controller 7 in the embodiments discussed herein is programmed with data tables, or math function based models, or one or more of each, for relating the input signals expected to be received with the modified, adapted, combined, or altered signals to be transmitted to the ECU, and, optionally, for relating controller control outputs to the input signals expected to be received or to ECU control signals. A controller 7 may further be programmed with control strategies for management of additional outputs additional to the outputs available from the ECU. As will be appreciated, the specific content of such programming, and specifically of such data tables, will vary depending on the vehicle in question, the specific sensor the controller 7 is intended to operate in connection with, the specific ECU in question, and, optionally, the specific parts, whether sensor or components, to which the controller 7 is operatively attached. The specific content of such programming, and specifically of such data tables and/or math functions, may also vary depending on the performance parameters intended to be achieved.

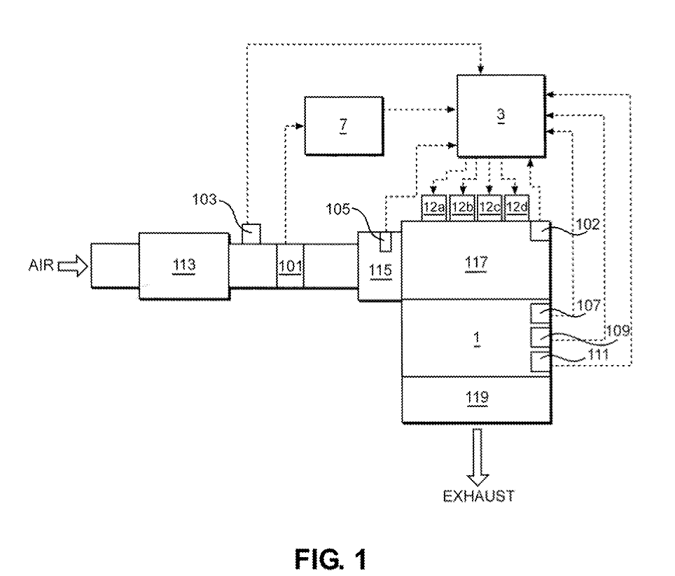

Turning now to the flow chart set forth in FIG. 1, in one embodiment, a controller 7 is interposed between at least one sensor, such as, as by way of illustrative example, a MAF sensor 101, and an ECU 3. The controller 7 is operatively connected, typically by electrical connection, to the ECU 3 and to the at least one sensor 101. When the vehicle is in operation, the sensor transmits input data to the controller 7. A digital MAF sensor, for example, may transmit the input signal as data in hertz. An analog MAF sensor, for example, may transmit the input signal as data in volts. The controller 7 modifies the input signal by at least one of scaling the input signal higher or lower according to a preselected ratio, altering the magnitude of the signal, or adapting the signal form one format to another—for example, from an analog (volts) format to a digital (hertz) format. In this embodiment, the system is useful for a variety of functions. For example, if an aftermarket sensor such as a MAF sensor is installed, that aftermarket sensor may generate input signals of a range of values, or in a format, different than those of a stock sensor. The ECU may be incapable of accepting or utilizing such input signals, or, alternately, may be programmed such that input signals may result in non-optimal ECU control output responses, or, still alternately, may not be reprogrammable in the desired ranges, as the ECU may have firmware limitations such as limitations on the maximum or minimum allowed input values, maximum or minimum allowed data table look up values, maximum or minimum allowed output values, or rationality checks inconsistent with the inputs being provided by the sensor. In this embodiment, the system can modify an input signal so that it is accepted by the ECU and results in a desired ECU control response, without the need to reprogram the ECU. As will be apparent, in this embodiment the controller 7 may modify input signals from any number of sensors and may perform multiple operations, such as one, two, three or more operations, or a combination of operations, on multiple input signals, such as one, two, three or more input signals, or any combination of signals, and may transmit to the ECU multiple signals, such as one, two, three or more signals, with the number of transmitted signals not necessarily equaling the number of input signals.

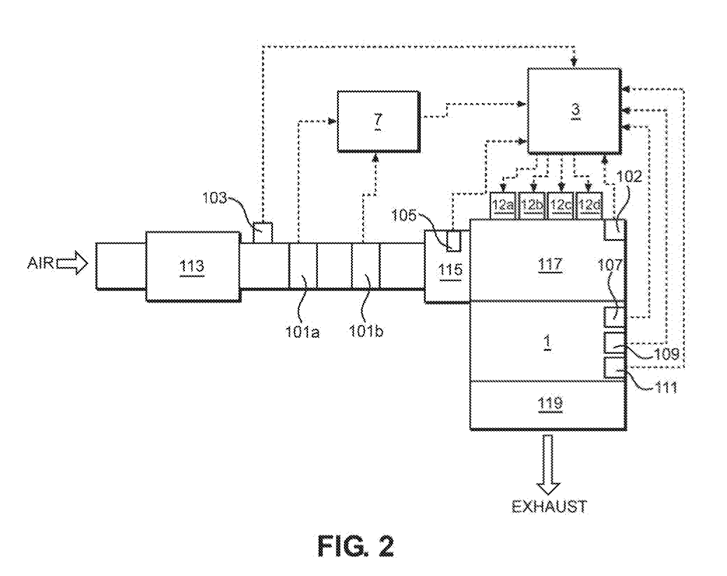

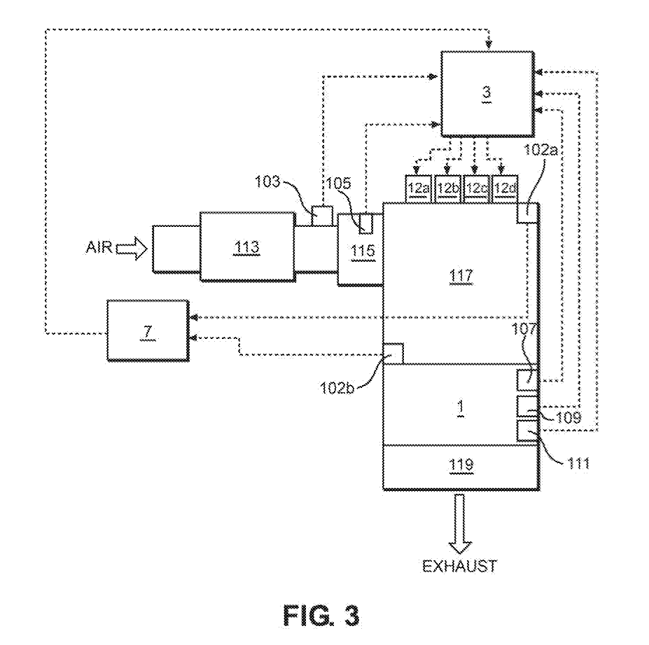

Turning now to the flow chart set forth in FIG. 2, in another embodiment, a controller 7 is interposed between at least two sensors, such as, as by way of illustrative example, two MAF sensors 101a, 101b, and an ECU 3. The controller 7 is operatively connected, typically by electrical connection, to the ECU 3 and to each sensor. When the vehicle is in operation, each sensor transmits input data to the controller 7. The controller 7 combines the input signals by adding, subtracting, or averaging them, and then transmits the combined input signal to the ECU 3. In this embodiment, the system is useful for a variety of functions. For example, if a vehicle includes only one MAF sensor 101, the user may desire to install additional MAF sensors to facilitate greater precision and accuracy in the detection of mass airflow, in turn facilitating a more efficient or higher-performing control response from the ECU. In these embodiments, the controller 7 may, as will be appreciated, also be used in connection with two MAP 102 sensors, as shown in FIG. 3, or with a mixture of sensors.

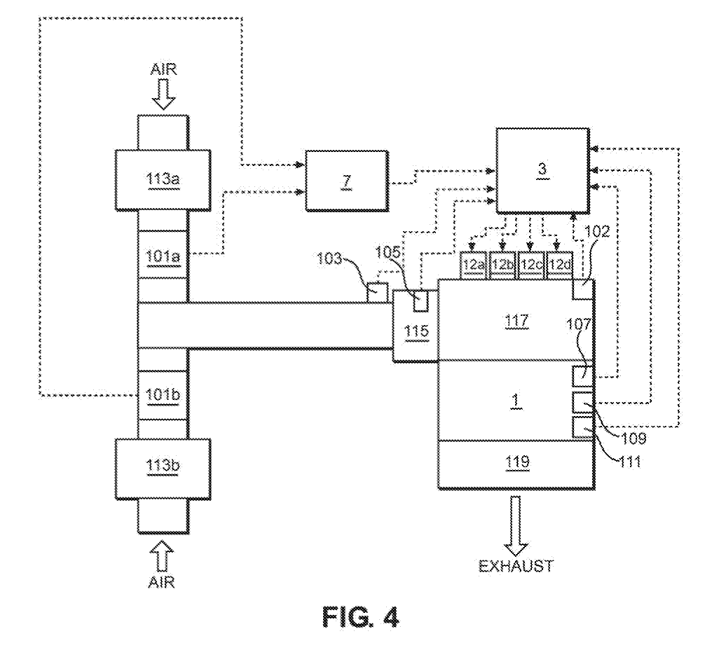

For further example, as illustrated by the flow chart set forth in FIG. 4, a user may desire to install a twin air inlet 113a, 113b to replace a single air inlet 113 to, by way of example, achieve desired airflow within the packaging constraints of the vehicle, to increase engine performance, power, and fuel economy, or to permit inlet airflow measurement to facilitate operation of a turbocharger 16. The ECU 3 may, however, not be configured or programmed to accept or utilize signals from the additional MAF sensors desired to be installed by the user. In these embodiments, the system may be utilized to accept input signals from any number of sensors, combine or statically or dynamically filter them as desired, and transmit a lesser number of combined signals to the ECU. In these embodiments, the controller 7 may also be capable of outputting sensor feedback, such as disabling one or more sensors that meet or fail to meet specific criteria. As will be apparent, in these embodiments the controller 7 may modify input signals from any number of sensors and may perform one, two, three or more operations, or a combinations or operations, on one, two, three or more input signals, or any combination of signals, and may transmit to the ECU one, two, three or more signals, with the number of transmitted signals not necessarily equaling the number of input signals, such as in the case where the controller 7 utilizes several input signals to calculate a single output. In each case, any combination is achieved through mathematical operation designed to adapt the multiple signals received by the controller 7 to the number, format, magnitude, and range of signals acceptable and useable by the ECU 3 to achieve the desired performance.

In another embodiment, a controller 7 is interposed between at least two sensors, such as, as by way of illustrative example, two MAF sensors, and an ECU 3. The controller 7 is operatively connected, typically by electrical connection, to the ECU 3 and to each sensor. When the vehicle is in operation, each sensor transmits input data to the controller 7, with a first sensor transmitting a first signal with a first signal timing, and a second sensor transmitting a second signal with a second signal timing. In this embodiment, the controller 7 alters the set of input signals by altering the timing, the order, or both, and then transmitting the altered set of signals to the ECU 3. In this embodiment, the system is useful for a variety of functions. For example, a user may desire to install one or more additional sensors to increase the accuracy of sensor inputs. For example, a user may install multiple MAF sensors to filter out electrical noise or erratic sensor readings caused by, for example, water or oil in the airflow impacting the MAF sensor. For further example, a user may install multiple MAP sensors to provide a more accurate signal with less pulsation from MAP variation from valve events, supercharger output pulses, intake runner tuning pulses, and the like. In another example, a user may install multiple sensors with differing operating ranges or sensitivities, and utilize the system and device herein both to mediate between the sensors and the ECU without programming of the ECU and to prioritize or filter (statically or dynamically) inputs from the multiple sensors based on other sensor readings, on the optimal operating ranges of those sensors, or on other criteria. For further example, in an engine with two or more MAF sensors, a user may desire to more precisely monitor the amount of airflow entering each cylinder, particularly under transient conditions such as changes in engine RPM, throttle angle, or load, where the MAF sensor delay can be significant and can cause incorrect airflow inputs to the ECU. The system and device of the present invention may, in one embodiment, incorporate multiple MAF sensors operatively connected to the controller 7 and the controller 7 may be programmed with data tables or math functions operating as compensation values or compensation strategies to delay one MAF input signal in relation to another to MAF input signal, and may output the modified compensated signals to the ECU, to compensate for sensor location and result in more accurate airflow readings inputted to the ECU.

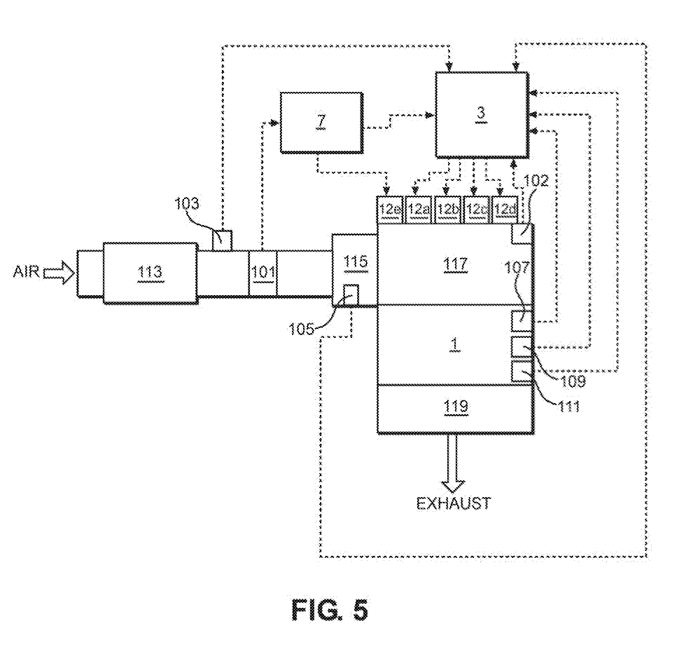

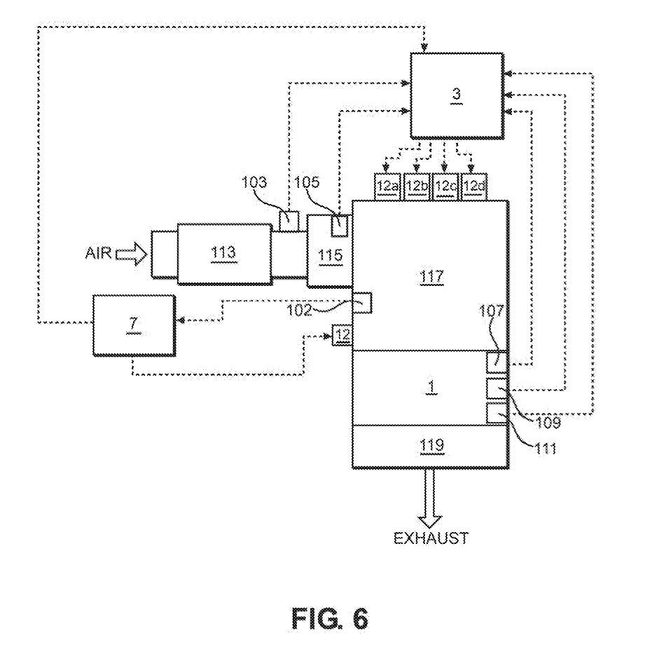

Turning now to the flow chart set forth in FIG. 5, in a preferred embodiment, a controller 7 is interposed between at least one sensor, such as, as by way of illustrative example a MAF sensor 101, and an ECU 3. The controller 7 is operatively connected, typically by electrical connection, to the ECU 3, to the sensor 101, and to at least one vehicle component other than the ECU, such as, by way of illustrative example, a throttle 115, one or more fuel injectors 12a, 12b, 12c, 12d, or an air valve. When the vehicle is in operation, the sensor transmits an input signal to the controller 7. If certain conditions are met, such as, for example, if the input signal exceeds the range of values the ECU 3 is configured or programmed to receive, the controller 7 clips the input signal and transmits to the ECU 3 a signal within the range of values the ECU 3 is configured or programmed to receive. The controller 7 may then, if programmed conditions are met, utilize the excess portion of the clipped signal to determine and deliver a control output to an automotive component. In this embodiment, the system is useful for a variety of functions. For example, a MAF sensor 101 may be connected operatively to the controller 7. At predetermined ranges of airflow, the controller may clip the input signal provided by the MAF sensor 101 and provide the clipped signal to the ECU 3. While the ECU 3 generates an ECU 3 output based on the clipped signal, upon the difference between the clipped and unclipped signal, or upon a math function related to the difference between the clipped and unclipped signals, the controller 7 may additionally or alternately provide a controller output based on the excess portion of the clipped signal, such as, for non-limiting example, to continue to provide the proper air or fuel amounts for the desired air/fuel ratio when the fuel required to maintain the desired ratio exceeds that obtainable within the limitations of the ECU's output values to the injector, when sensor reading values pertaining to airflow exceed the ECU's limitations, when sensor reading values pertaining to manifold air pressure exceed the ECU's limitations. As will be appreciated, these embodiments of the invention may utilize a mixture of sensors, or may utilize MAP 102 sensors, as shown in FIG. 6.

As will be apparent, embodiments of the present invention may be used to improve vehicle performance or efficiency, or avoid the need to program an ECU, in a broad variety of contexts. For further example, embodiments of the present invention may be used:

To convert the signal of an aftermarket MAF of the same signal type as an OEM MAF so that the airflow vs output is recognized by the ECU the same as the original sensor;

To convert the signal of an aftermarket MAF of a different signal type as an OEM MAF so that the airflow vs output is recognized by the ECU the same as the original sensor;

To allow the use of additional MAF sensors in series in the same air duct, such as to account for the differences in location of the sensors along the duct and compensate for the time lag between the sensors and to provide an average, and optionally filtered, signal to the ECU, optionally within the same signal vs airflow relationship recognized by the ECU without reprogramming;

To allow the use of multiple MAF sensors in parallel, such as in separate air ducts branches ahead of a junction, to provide the ECU with a combined signal proportional to the total airflow entering the engine;

To enable more efficient performance despite any ECU's programmed airflow limit/signal limit, by providing a signal from a MAF sensor (or a combined or averaged signal from multiple MAF sensors) within the ECU's limit, clipping the signal if necessary, and in response to any excess signal value proportional to the total airflow, directing auxiliary fuel injectors, and, optionally, fuel pressure regulators or pumps, to supply the additional fuel called for based on the difference between the input signal and the clipped output signal;

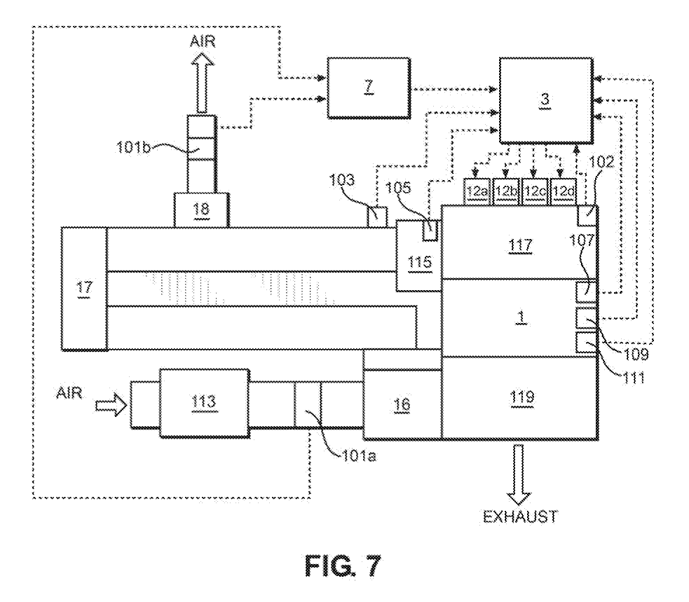

As shown in FIG. 7, to correct the airflow signal received by an ECU in a vehicle with an aftermarket supercharger or turbocharger and an aftercooler 17 by accepting signals from at least a primary MAF sensor located in the inlet prior to a supercharger or turbocharger 16 and from at least a secondary MAF sensor placed in the duct leading to or from a blow-off valve 18, subtracting airflow measured by a secondary MAF sensor from airflow measured by a primary MAF sensor, and outputting the revised airflow signal to the ECU;

To correct the airflow signal received by an ECU by modifying the signal received from at least one MAF sensor according to other sensor inputs;

To allow the use of at least one additional manifold air pressure sensor along different locations in an intake manifold by averaging the signals from the additional sensors with the signal of the original sensor to provide a signal to the ECU recognized by the ECU without reprogramming;

To compare the function of one sensor to another sensor to determine if both sensors are functioning correctly, and, if one sensor is determined to be non-operational or operating outside of desired parameters, institute control outputs to, by way of example, disable the malfunctioning sensor;

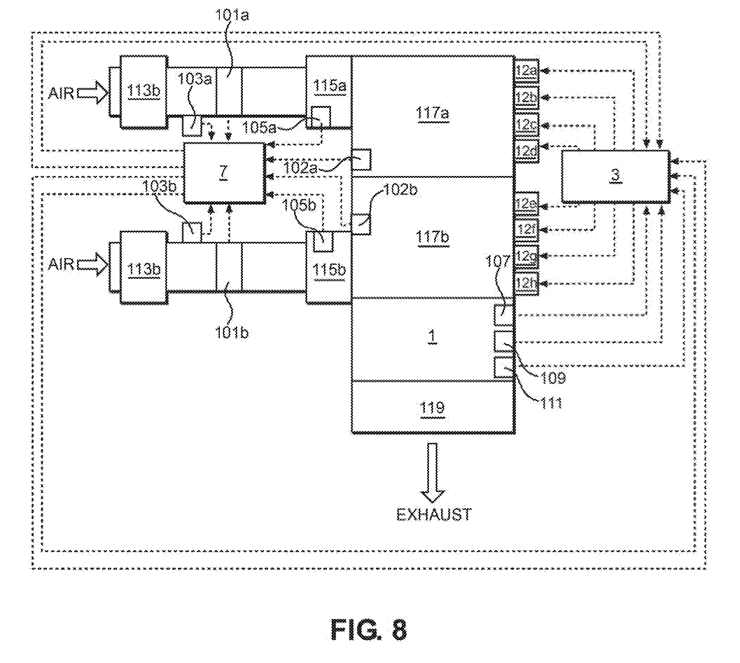

To, by averaging the signals from to MAF sensors, two IAT sensors, and two TPS sensors, allow an ECU configured for a single throttle intake manifold to run an engine with a twin plenum, twin throttle intake, as shown in FIG. 8.

Although the present invention has been described in considerable detail with reference to certain preferred versions thereof, other versions are possible. Each, or several, of the embodiments of the system described herein may be used simultaneously, used in parallel, or combined into a single system. Further, sensor types other than those named specifically herein, and control outputs and mathematical operations other than those illustratively discussed, may be used within the scope and spirit of this invention.

What is claimed is:

1. A system for use with a combustion engine, said system comprising:
a controller operatively connected to the ECU and further operatively connected to at least one sensor, wherein said controller is programmed to receive input signals from said at least one sensor, modify said input signals, and transmit said modified input signals to said ECU, wherein said signals transmitted to said ECU by said device are modified by said device by an operation selected from the group consisting of: increasing the magnitude of said input signals, decreasing the magnitude of said input signals, scaling said input signals according to a selected function of input values, altering the timing of said input signals, altering the order of said input signals, scaling said input signals according to a selected factor, adapting said input signals from a first format to a second format wherein said second format is compatibly receivable by said ECU, utilizing at least one of said input signals to determine at least one output signal to at least one part not including an ECU, and any combination thereof.

2. The system of claim 1, wherein said controller is programmed through the use of at least one of a data table, or a math function, or any combination thereof.

3. The system of claim 2, wherein said controller is operatively connected to at least two sensors.

4. The system of claim 3, wherein said controller modifies said input signals by altering the order of transmission to the ECU of at least a first input signal or a second input signal, or any combination thereof.

5. The system of claim 1, wherein said controller is operatively connected to at least one automotive component, and said controller is programmed to provide control outputs to said at least one automotive component.

6. The system of claim 5, wherein said control outputs are a determined as a function of at least one of said modified input signal or a control output received by said controller from said ECU, or any combination thereof.

7. A system for use with a combustion engine, said system comprising:
a controller operatively connected to the ECU and further operatively connected to at least two sensors, wherein said controller is programmed to receive input signals from each of the at least two sensors, combine said input signals, and transmit said combined input signals to said ECU, wherein said input signals are combined by said device by an operation selected from the group consisting of: adding said input signals to each other, subtracting one of said input signals from another of said input signals, averaging said input signals, and any combination thereof.

8. The system of claim 7, wherein said controller is programmed through the use of at least one of a data table, or a math function, or any combination thereof.

9. The system of claim 8, wherein said controller is operatively connected to at least one automotive component, and said controller is programmed to provide control outputs to said at least one automotive component.

10. The system of claim 9, wherein said control outputs are a determined as a function of at least one of said combined input signal, or a control output received by said controller from said ECU, or any combination thereof.

11. A system for use with a combustion engine, said system comprising:
a controller electrically connected to an ECU, to at least one sensor, and to at least one automotive component other than said ECU, wherein said controller is programmed to receive an input signal of a first value from said at least one sensor, clip said input signal to a second value, and provide a control output to said at least one automotive component, wherein said control output is a determined as a function of the difference between said first value and said second value.

12. The system of claim 11, wherein said controller is programmed through the use of at least one of a data table, or a math function, or any combination thereof.

13. The system of claim 12, wherein said controller transmits said clipped input signals to said ECU.

14. The system of claim 12, wherein said control outputs are further determined as a function of a separate control output provided by said ECU.

15. The system of claim 12, wherein said controller is electrically connected to at least two sensors.

16. The system of claim 12, wherein said controller is electrically connected to at least two automotive components other than said ECU.
